(19) United States
(12) Patent Application Publication
(10) Pub. No.: US 2006/0009102 A1
(43) Pub. Date: Jan. 12, 2006

(54) Composite material for articles which come into contact with liquid or pasty foodstuffs

(76) Inventors: Karl-Heinz Blomeyer, Bodenfelde (DE); Thomas Perkovic, Borenden (DE)

Correspondence Address: WALTER OTTESEN, PO BOX 4026, GAITHERSBURG, MD, 20885-4026, US

(21) Appl. No.: 11/171,230

(22) Filed: Jul. 1, 2005

(30) Foreign Application Priority Data
Jul. 1, 2004 (DE) 10 2004 031 812.3

(51) Int. Cl. B32B 3/00

(52) U.S. Cl. 442/59; 442/1; 442/181

(57) ABSTRACT

A composite material is provided for articles which come into contact with liquid or pasty foodstuffs and especially for drinking water vessels. The composite material includes a textile, lattice-like middle layer which is free of bonding agents. The middle layer is arranged between two bonding agent free cover layers which are on the basis of synthetic rubber. The cover layers are bonded to each other material-tight via the open intermediate spaces of the textile, lattice-like middle layer.

### CROSS REFERENCE TO RELATED APPLICATION

This application claims priority of German patent application no. 10 2004 031 812.3, filed Jul. 1, 2004, the entire content of which is incorporated herein by reference.

### FIELD OF THE INVENTION

The invention relates to a composite material for articles which come into contact with liquid or pasty foodstuffs. The invention is especially directed to a composite material for drinking water vessels.

### BACKGROUND OF THE INVENTION

Drinking water is a water which is suitable for human consumption and enjoyment and must satisfy strict requirements established in various statutory standards. As the most important and irreplaceable foodstuff, drinking water must be free of infectious agents and may have no characteristics which can injure health. Drinking water must be virtually germ free, appetizing, colorless and odorless, cool and there should be no objection with respect to the taste thereof.

In problem or crisis situations, the drinking water supply of the people is usually ensured in that the drinking water is made available in vessels. These problem or crisis situations include, for example, accidents, interruptions in the public water supply, drought, flooding, environmental contamination or terrorism attacks.

Vessels of this kind for transport and storage of drinking water are known in various embodiments and are made, for example, of steel or plastic. It is disadvantageous with respect to these vessels that they are usually configured to be rigid and cannot be stored or transported in a space-saving manner when they are empty. Vessels of steel furthermore have the disadvantage that they rust relatively quickly in dependence upon the drinking water quality and the ambient temperature and must be exchanged. Flexible vessels made of plastic such as polypropylene are known; however, they do not provide the stability needed for manipulation, transport and storage thereof.

Plastic sacks made of polypropylene and filled with drinking water which are placed, for example, in stable plastic containers are known. The plastic containers themselves have no direct contact with the drinking water. After consumption of the drinking water, the polypropylene sacks can be disposed of and the empty plastic containers can be collapsed, if required, and transported for renewed use or stored. It is disadvantageous in this system that the polypropylene sacks themselves have only a low mechanical stability and low capability to withstand load and therefore are very much subject to damage. In addition, the known plastic containers can be collapsed to save space only to a limited extent.

The above-described problems relate primarily also to the storage or transport of pasty foodstuffs such as food pastes, margarine, cream cheeses and the like.

### SUMMARY OF THE INVENTION

In view of the above, it is an object of the invention to provide a material for articles, which come into contact with liquid or pasty foodstuffs. The invention is especially directed to a material for drinking water vessels. It is a further object of the invention to provide a material for these purposes which is mechanically stable and can be subjected to load and which does not affect the quality of the foodstuffs.

The material of the invention for articles, which come into contact with liquid or pasty foodstuffs, is a composite material which comprises a textile, lattice-like middle layer which is free of bonding agents and which lies between two cover layers. The cover layers are free of bonding agents and are on the basis of synthetic rubber which is preferably butyl rubber or ethylene-propylene rubber. The cover layers are materially joined to each other through the open intermediate spaces of the textile, lattice-like middle layer.

A composite material of this kind is flexible as well as mechanically stable and can be subjected to load. The flexibility is especially provided by the use of cover layers on the basis of synthetic rubber, preferably of butyl rubber or ethylene-propylene rubber. The textile, lattice-like middle layer provides for the required mechanical stability.

According to the invention, neither the middle layer nor the cover layers have bonding agents. In this way, it is ensured that no bonding agents can escape from the composite material into the foodstuffs when the latter come into contact with the composite material of the invention. The foodstuff quality, especially the drinking water quality, is therefore not affected.

Bonding agents are substances which serve to improve the adherence of materials which are to be combined with each other. In the composite material of the invention, bonding agents are surprisingly not required. The material-tight connection of the cover layers in the intermediate spaces of the textile, lattice-like middle layer leads to an excellent fixation of the middle layer within the composite material and imparts an exceptionally good mechanical stability and capability to withstand load to the composite material.

The composite material of the invention satisfies the requirements according to the KTW Recommendations for plastics and drinking water for the area of application in “vessels, equipment articles as well as large area and small area seals” in the temperature range of cold water. The above-mentioned KTW Recommendations were published in the years between 1977 to 1987 by the working group “Trinkwasserbelange” of the Plastic Commission of the then German Federal Health Office (Bundesgesundheitsamt (BGA)) in the publication “deutsches Bundesgesundheitsblatt”.

The tight surface of the composite material of the invention makes the penetration of microorganisms into deeper layers difficult and limits their possible growth on the surface so that the composite material of the invention also satisfies the requirements of the German organization DVGW (Deutsche Vereinigung des Gas- und Wasserfaches, e.V.) Worksheet W 270 and is therefore suitable for use in the area of drinking water from a microbiological viewpoint.

Important advantages to the invention include: the chemical inertness; the omission of bonding agents; and, the special surface characteristics of foodstuff vessels produced with the composite material. For the use in drinking water vessels, the smooth surface of the composite material is decisive which affords microorganisms little adherence possibilities and little breeding possibilities.

Drinking water vessels, which comprise the composite material of the invention, are distinguished by their flexibility as well as their very good mechanical stability and subjectability to load. Accordingly, it is possible to manufacture drinking water vessels which contain several thousand liters of drinking water. The possibilities of use of such drinking water vessels are correspondingly many. It is advantageous that the drinking water vessels in the unfilled state can be transported or stored while at the same time saving space because of their flexibility.

The composite material of the invention can also be applied for lining drinking water vessels and especially for lining drinking water vessels which are in need of refurbishment.

A use of the composite material of the invention is advantageous in metering devices for the controlled discharge of pasty foodstuffs for the conveying membrane or metering membrane.

A further embodiment of the invention provides that the composite material is produced in that the textile middle layer is calendered on both sides to the cover layers and the composite material made in this way is subsequently vulcanized.

Preferably, the textile net-like middle layer is a woven fabric or a warp-knitted fabric.

According to an advantageous embodiment of the invention, the material of the textile, lattice-like middle layer comprises synthetic raw materials, preferably, polyester, polyamide, polyaramide, polyimide or mixtures of these raw materials.

It is understood that additives can be added to the cover layers during the making thereof. These cover layers are on the basis of synthetic rubber, preferably, butyl rubber or ethylene-propylene rubber. The type and quantity of the additive is dependent upon the wanted characteristics of the composite material of the invention. Additives of this kind are known to persons of ordinary skill working in the area of composite materials. The addition of the additive is, however, limited in that the composite material, which is produced in accordance with the invention, may not affect the foodstuff quality and especially not affect the drinking water quality when the composite material comes into contact with the foodstuffs and especially with the drinking water.

### BRIEF DESCRIPTION OF THE DRAWINGS

The invention will now be described with reference to the drawings wherein:

FIG. 1 is a section view of an embodiment of the composite material of the invention in advance of joining and vulcanization; and,

FIG. 2 shows the composite material made of the three layers of FIG. 1 after pressing and complete vulcanization.

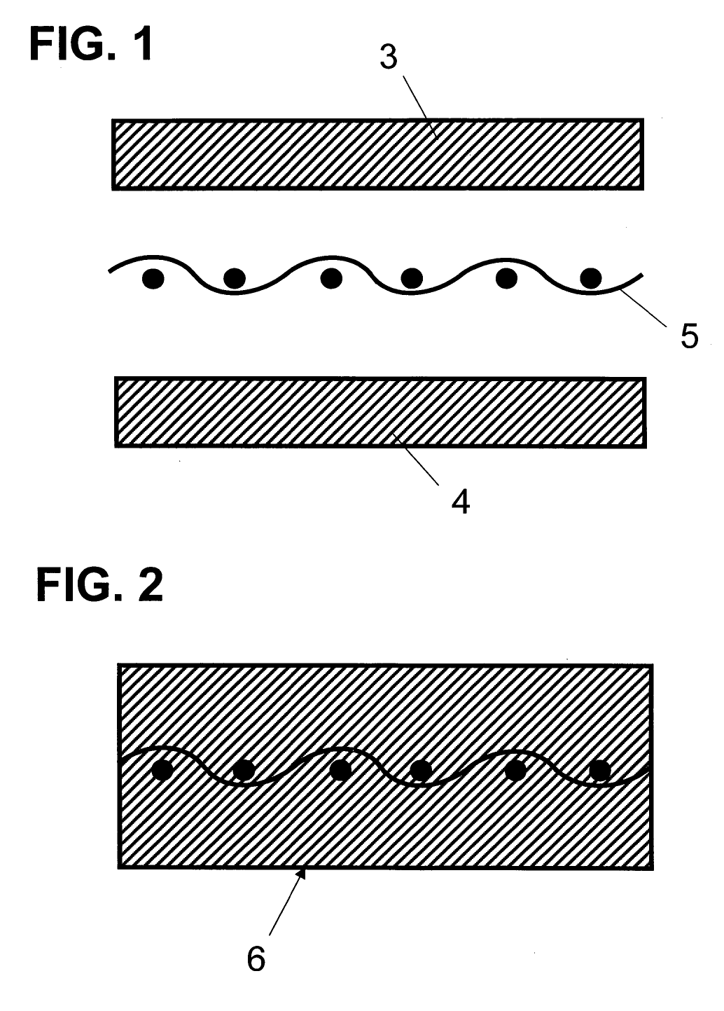

### DESCRIPTION OF THE PREFERRED EMBODIMENTS OF THE INVENTION

The composite material is made of an upper cover layer 3 of butyl rubber and a lower cover layer 4 likewise of butyl rubber. A textile middle layer 5 is arranged between the cover layers 3 and 4. The middle layer 5 comprises a fabric in the form of a polyester fabric.

According to another embodiment of the invention, the composite material can be a membrane comprising EPDM-rubber (ethylene-propylene-diene rubber) having a middle layer in the form of polyamide fabric.

The three layers (3, 4, 5) are placed one atop the other and are completely vulcanized under pressure. A boundary layerless composite material 6 (FIG. 2) results wherein the rubber of the upper cover layer and the rubber of the lower cover layer get into the intermediate spaces of the textile, lattice-like middle layer 5 and are joined material-tight to each other.

It is understood that the foregoing description is that of the preferred embodiments of the invention and that various changes and modifications may be made thereto without departing from the spirit and scope of the invention as defined in the appended claims.

What is claimed is:

1. A composite material for articles, which come into contact with liquid or pasty foodstuffs, the composite material comprising:
first and second cover layers made on the basis of synthetic rubber and said first and second cover layers being free of bonding agents;
a textile lattice-like middle layer being likewise free of bonding agents and defining a plurality of open intermediate spaces;
said textile lattice-like middle layer being disposed between said first and second cover layers; and,
said first and second cover layers being joined material-tight to each other via said open intermediate spaces.

2. The composite material of claim 1, wherein said synthetic rubber is butyl rubber or ethylene-propylene rubber.

3. The composite material of claim 1, wherein said textile lattice-like middle layer is calendered on both sides with said first and second cover layers.

4. The composite material of claim 3, wherein said layers are vulcanized.

5. The composite material of claim 1, wherein said middle layer comprises a woven fabric or a warp-knitted fabric.

6. The composite material of claims 1, wherein said middle layer comprises a synthetic material selected from the following: polyester, polyamide, polyaramide, polyimide or a mixture thereof.

7. The composite material of claim 1, wherein said synthetic rubber is EPDM-rubber.

8. The composite material of claim 7, wherein said middle layer is a polyamide fabric.

9. The composite material of claim 1, wherein said composite material is in the form of a membrane.
